(19) United States
(12) Patent Application Publication
(10) Pub. No.: US 2009/0009341 A1
(43) Pub. Date: Jan. 8, 2009

(54) Device, method and/or system for monitoring the condition of a subject

(76) Inventor: Alexander Gak, Fort Lee, NJ (US)

Correspondence Address: DINESH AGARWAL, P.C., 5350 SHAWNEE ROAD, SUITE 330, ALEXANDRIA, VA, 22312, US

(21) Appl. No.: 11/822,322

(22) Filed: Jul. 5, 2007

(51) Int. Cl. G08B 23/00

(52) U.S. Cl. 340/573.1

(57) ABSTRACT

A device, method, and/or system for monitoring the condition of a subject includes an input member for generating one or more signals, a processor for receiving one or more signals from the input member and measuring a time elapsed since the last signal, and a monitor for indicating a severe distress, moderate distress, mild distress, or no distress condition for the subject based on the time elapsed.

### FIELD AND BACKGROUND OF THE INVENTION

The present invention is generally directed to a health care device, and more particularly, to a device, method and/or system for monitoring the condition of a subject for guiding therapy.

Pain is a serious problem in medical and surgical patients. Pain leads to sleep disturbances producing exhaustion and agitation. It augments stress response leading to increased oxygen consumption, hypercoagulobility, immunosupression and poor healing.

Today, the state-of-the art modalities to assess pain in awake patients consist of self-reporting methods such as Visual Analog Scale (VAS) (FIG. 3) and Numerical Rating Scale (NRS).

The existing methods require a healthcare provider to see the patient and perform pain assessment. It is not unusual to encounter the type of practice where pain assessments are seldom done during nursing shifts or done only upon multiple requests from patients. Such practice results in prolonged painful intervals and leads to negative physiological and psychological effects.

Various communication/assessment/patient-responsive systems are disclosed in U.S. Patents/Patent Application Publications Nos. 4,493,043; 5,069,668; 6,759,607; 2003/0230469; 2006/0105301; 2006/0128263; and 2006/0294108.

### OBJECTS AND BRIEF SUMMARY OF THE INVENTION

An object of the present invention is to provide a device, method and/or system for monitoring the condition of a subject.

Another object of the present invention is to provide a device, method and/or system for reporting the condition of a subject.

Another object of the present invention is to provide a device, method and/or system for monitoring or reporting the condition of a subject on a real-time basis to better access evolution of patient's painful distress, efficacy of therapy, and/or performance of the healthcare team.

Another object of the present invention is to provide a device, method and/or system for monitoring or reporting the condition of a subject wherein the patient takes on an active role in his or her pain control and management process.

Another object of the present invention is to provide a device, method and/or system for monitoring or reporting the condition of a subject which eliminates the need for a healthcare provider to personally see the patient for pain review, analysis, or assessment.

Another object of the present invention is to provide a device, method and/or system for monitoring or reporting the condition of a subject which improves participation and performance of the pain management process by making the pertinent data available effectively instantly to various members on an intra-office, inter-office, local, national or worldwide network.

Another object of the present invention is to provide a device, method and/or system for monitoring or reporting the condition of a subject wherein painful distress reports provide evidence necessary for effective changes in therapeutic regimen.

Another object of the present invention is to provide a device, method and/or system for monitoring or reporting the condition of a subject wherein better pain control is achieved through tailoring the analgesic regimen to the reported pattern of pain and through active patient participation and improved compliance.

Another object of the present invention is to provide a device, method and/or system for monitoring or reporting the condition of a subject which continuously communicates the level of urgency in pain assessment and management intervention.

Another object of the present invention is to provide a device, method and/or system for monitoring or reporting the condition of a subject which provides transparency in adequacy of pain management for all patients in a healthcare unit.

Another object of the present invention is to provide a device, method and/or system for monitoring or reporting the condition of a subject which records and reports patient's data to improve performance.

Another object of the present invention is to provide a device, method and/or system for monitoring or reporting the condition of a subject which allows for better compliance with pain assessment and management standards of The Joint Commission on Accreditation of Healthcare Organizations (JCAHO).

Another object of the present invention is to provide a device, method and/or system for monitoring or reporting the condition of a subject which is easy to implement and follow.

Another object of the present invention is to provide a device, method and/or system for monitoring or reporting the condition of a subject which leads to better physical and mental health of a patient.

Another object of the present invention is to provide a device, method and/or system for monitoring or reporting the painful distress as well as the well-being condition of a subject. For instance, the present invention can be used to assess and manage physical or emotional pain, as well as to assess and manage, for example, the efficacy of anti-depressant therapy in a psychiatric patient.

In summary, the main object of the present invention is to provide a device, method and/or system for monitoring or reporting the condition of a subject which empowers a patient by giving him or her an active role in pain management process by continuously communicating on a real-time basis the patient's current state of, for example, painful distress condition to a healthcare provider.

One of the above object is met, in part, by the present invention which in one aspect includes a device for monitoring the condition of a subject, including an input member for generating one or more signals, a processor for receiving one or more signals from the input member and measuring a time elapsed since the last signal, and a monitor for indicating the condition of a subject.

Another aspect of the present invention includes a device for monitoring the condition of a subject, which includes an input member for generating one or more user-initiated signals, a processor for receiving one or more signals from the input member and measuring a time elapsed since the last signal, and a monitor for indicating a severe distress, moderate distress, mild distress, or no distress condition for the subject.

Another aspect of the present invention includes a device for monitoring the condition of a subject, which includes an input member for generating one or more signals, a processor for measuring a time elapsed since receiving the last signal from the input member, and a monitor for indicating a condition of the subject.

Another aspect of the present invention includes a system for reporting the condition of a subject, which includes an input member for generating one or more user-initiated signals, and a processor for receiving one or more signals from the input member and measuring a time elapsed since the last signal. The processor also records time and frequency data for the signals over a predetermined period.

Another aspect of the present invention includes an outpatient painful distress reporting system, which includes a patient input member for generating one or more signals in each instance of the occurrence of a painful stimulus, a processor for receiving one or more signals from the patient input member and measuring a time elapsed since the last signal, and a monitor for indicating a severe distress, a moderate distress, a mild distress, or no distress condition for the patient. The processor also records time and frequency data for the signals and the condition of the patient over a predetermined period.

Another aspect of the present invention includes a method of monitoring the condition of a subject, which includes providing an input member to a user for generating a signal in each instance of the occurrence of a stimulus, measuring a time elapsed since receiving the last signal from the input member, and indicating a condition of the subject based on the time elapsed.

Another aspect of the present invention includes a method of reporting the condition of a subject, which includes providing an input member to a user for generating a signal in each instance of the occurrence of a stimulus, measuring a time elapsed since receiving the last signal from the input member, indicating a condition of the subject based on the time elapsed, and recording time and frequency data for the signals over a predetermined period.

### BRIEF DESCRIPTION OF THE DRAWINGS

One of the above objects, novel features and advantages of the present invention will become apparent from the following detailed description of the preferred embodiment(s) invention, as illustrated in the drawings, in which:

FIG. 1 is a block diagram illustrating the basic components of the device of the present invention;

FIGS. 2A-2C is a flow diagram of the process of the present invention;

FIG. 3 illustrates a conventional visual analog scale for determining distress;

FIG. 4 is a graph illustrating visual representation of the severity of painful distress plotted against time since the last user input;

FIGS. 5A-5D are schematic diagrams of a color-coded monitor for indicating four different distress levels;

FIG. 6 is a schematic diagram showing the basic components of a painful distress reporting/management system; and

FIG. 7 illustrates a sample painful distress management chart/report.

### DETAILED DESCRIPTION OF THE PREFERRED EMBODIMENT(S) OF THE INVENTION

The present invention is based, in part, on the principle of patient controlled analgesia (PCA), underlying which is the idea that patients in greater painful distress press PCA button more frequently. The ability to increase frequency of administration of pain medication in proportion to the level of painful distress, allows a patient to obtain the required plasma analgesic concentrations and, therefore, better pain relief.

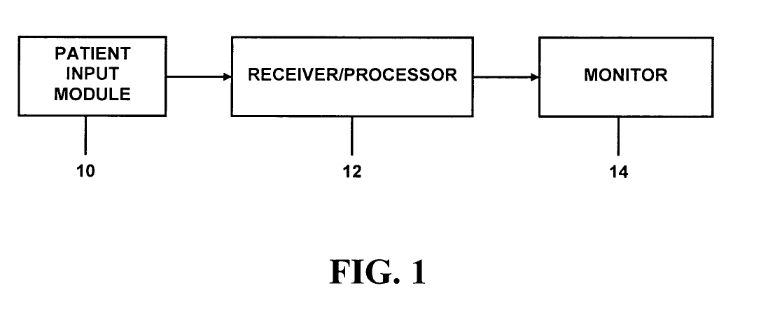

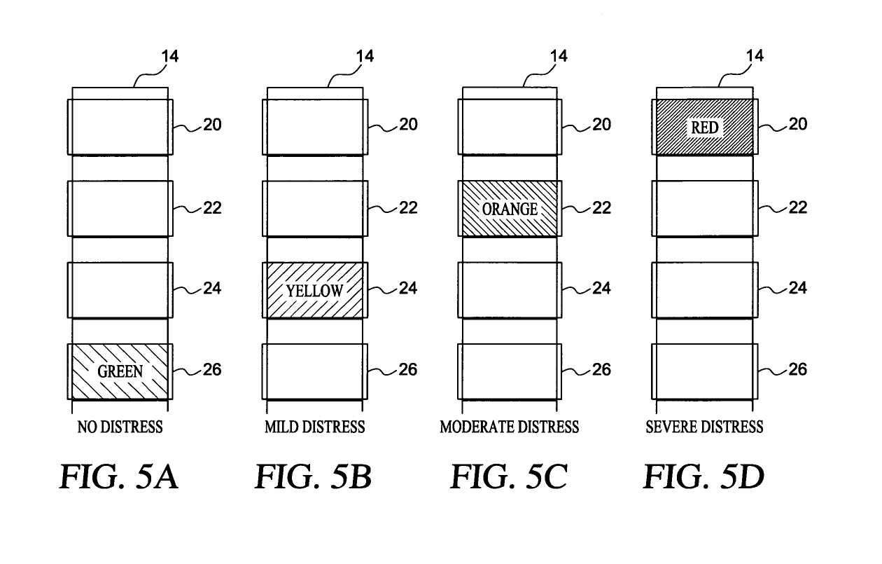

In the present invention, a subject, such as a patient under healthcare for pain assessment or management, is provided with an input module or device 10, and is instructed to press a button at each instance of the occurrence of a pain stimulus (FIG. 1). The input module 10 transmits a signal to a receiver/processor 12, which records the time and data for the signal received from the input module 10, and measures the time elapsed since the last signal. Based on the time elapsed since the last signal, a monitor 14 displays, preferably in a color-coded scheme similar to VAS, the level of the patient's pain distress (FIGS. 5A-5D).

The following table illustrates the color-coded scheme for indicating the painful distress level in accordance with the present invention.

Color Scheme for Indicating Painful Distress Level

| Time Category | Time Elapsed | Color | Distress Level |
|---|---|---|---|
| Short | 0-about 5 min. | Red | Severe |
| Intermediate | >about 5 to about | Orange | Moderate |
| | 15 min. | | |
| Longer | >about 15 to | Yellow | Mild |
| | about 30 min. | | |
| Longest | >about 30 min. | Green | None |

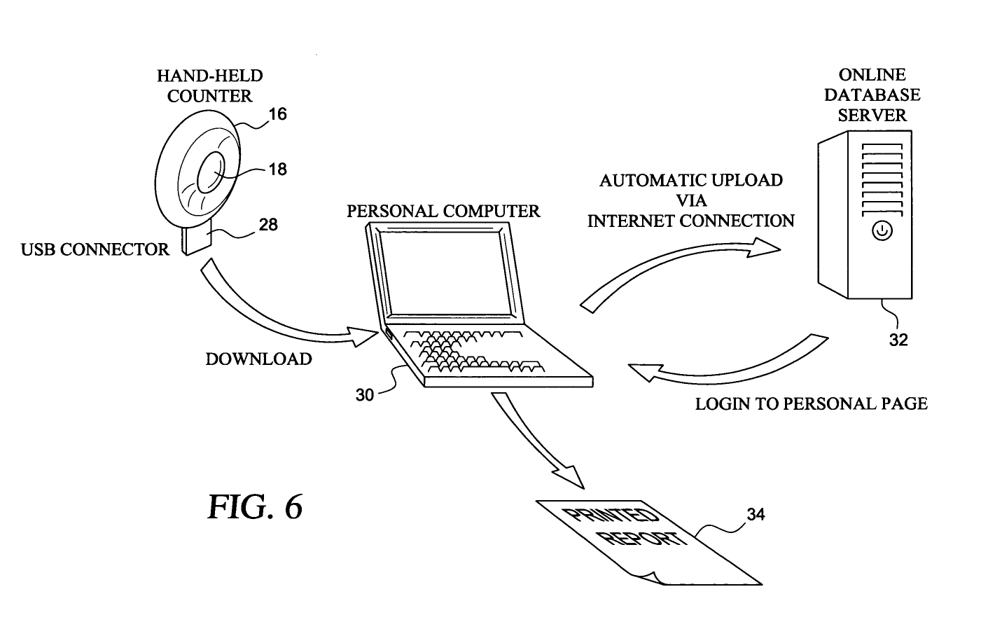

The patient input module is preferably in the form of a hand-held counter 16 with a button 18 (FIG. 6). It is noted herewith, however, that the input module 10 can be any device that can be used to transmit a signal, repeatedly at will, such as a pointing device (computer mouse), a data entry device (keyboard), a telephone, a cell phone, a personal data assistant (PDA), a desktop computer, a laptop computer, a portable computing device, or a remote control device. Likewise, the receiver/processor 12 can be any conventional component or device that can be used to receive and process electronic signals or data for further storage and processing. It can be separate from, or be made as a component of the patient input module 10.

As shown in FIG. 5, the monitor 14 preferably includes four vertically arranged conventional display panels 20, 22, 24 and 26, which upon receiving a signal illuminate different colors. As an illustration, the display panels 20, 22, 24 and 26 illuminate in red, orange, yellow and green colors for indicating severe distress, moderate distress, mild distress, and no distress conditions, respectively, for a patient.

It is noted herewith that the time categories, elapsed times and the color scheme shown herein for indicating the corresponding distress levels for a patient, can be varied or substituted for other desired means. In addition, the number of the illustrated categories can also be changed. For example, the categories for four distress levels may be further refined up so as to have more distress levels, or down so as to have fewer levels.

It is further noted herewith that instead of, or in addition to the visual color-coded display, the monitor 14 may include the capability for indicating the condition of a patient by an audio or an audio-visual signal, or a text or other messaging means or technique.

Referring to FIG. 6, an outpatient painful distress reporting system includes the hand-held counter 16 with preferably a USB connector 28 for downloading the time and date data for each press of the button 18 by a patient, to a personal computer 30, directly, wirelessly or through an Internet connection. The downloaded data is preferably automatically uploaded to an online database server 32, directly, wirelessly or via an Internet connection, for storage and providing access to various care providers for assessment, analysis, etc. A painful distress report 34 can be generated for assessment and therapy.

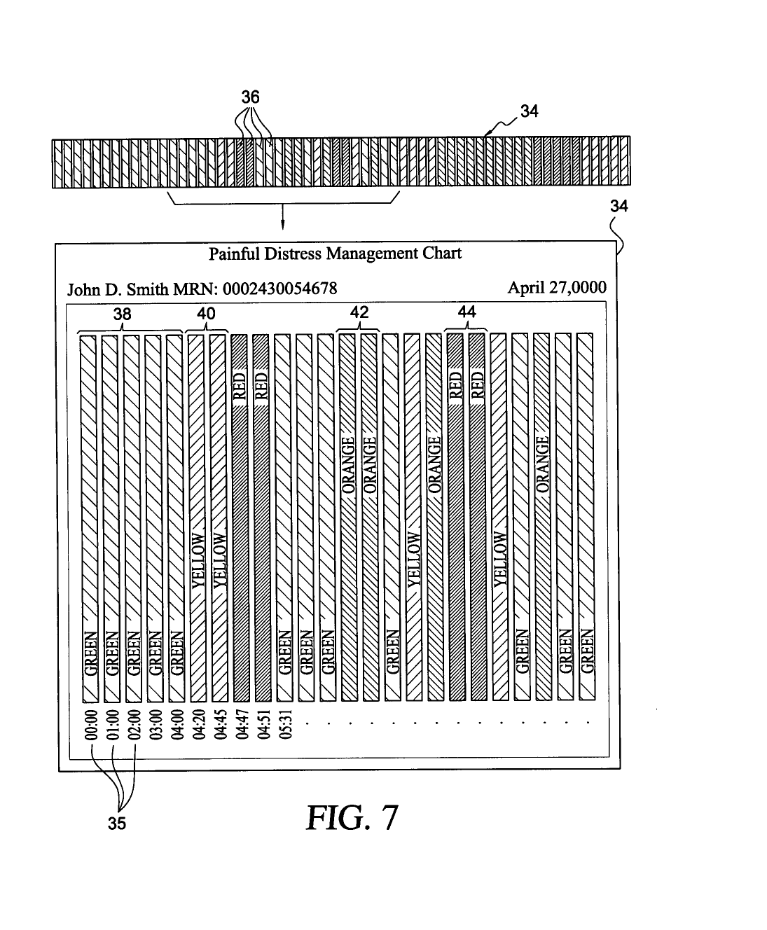

As best shown in FIG. 7, the report 34 is preferably in the form of a bar chart where each bar 36 represents each instance the button 18 was activated by the patient, with the associated time-stamp 35. Further, the bars 36 are preferably color-coded to correspond with the above-mentioned color-coded scheme to indicate the distress level. For example, group 38 of bars indicates no distress condition for a patient. Likewise, groups 40, 42 and 44 indicate mild distress, moderate distress, and severe distress levels, respectively, for the patient. It is noted herewith that other means may alternatively be used to indicate or show the patient distress level on the report 34 over a predetermined period. Further, the data collected may be manipulated to produce various other reports. For instance, the patient input data for a specific time interval, e.g., 12-hours, may be analyzed to show whether a particular distress condition dominated during that time interval. The dominance factor could be selected by the care provider and may range from, for example, about 20-90%.

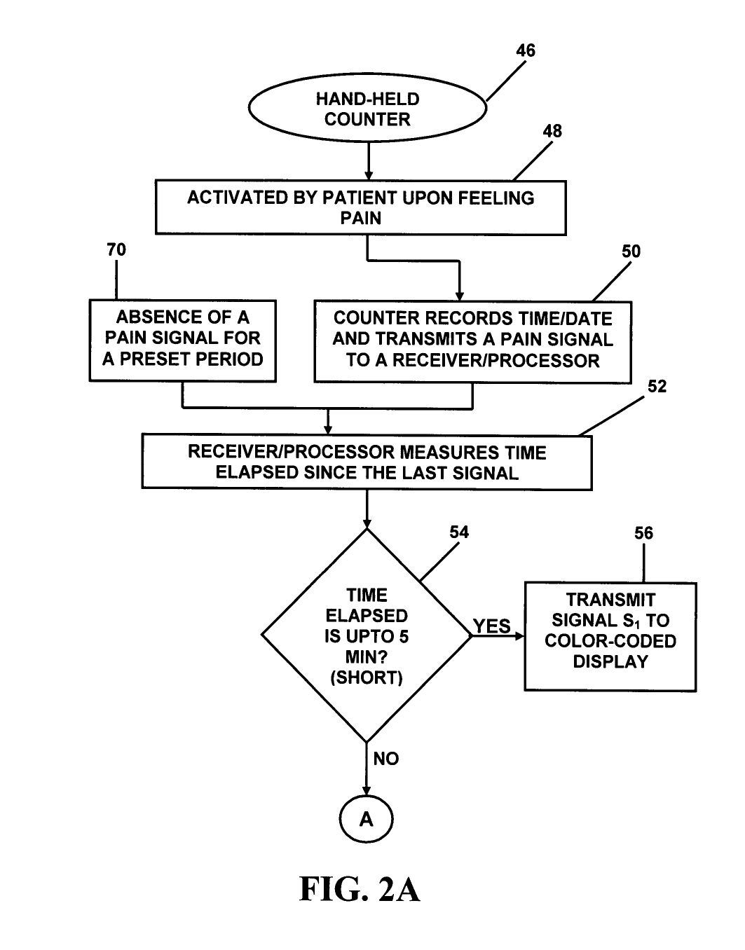

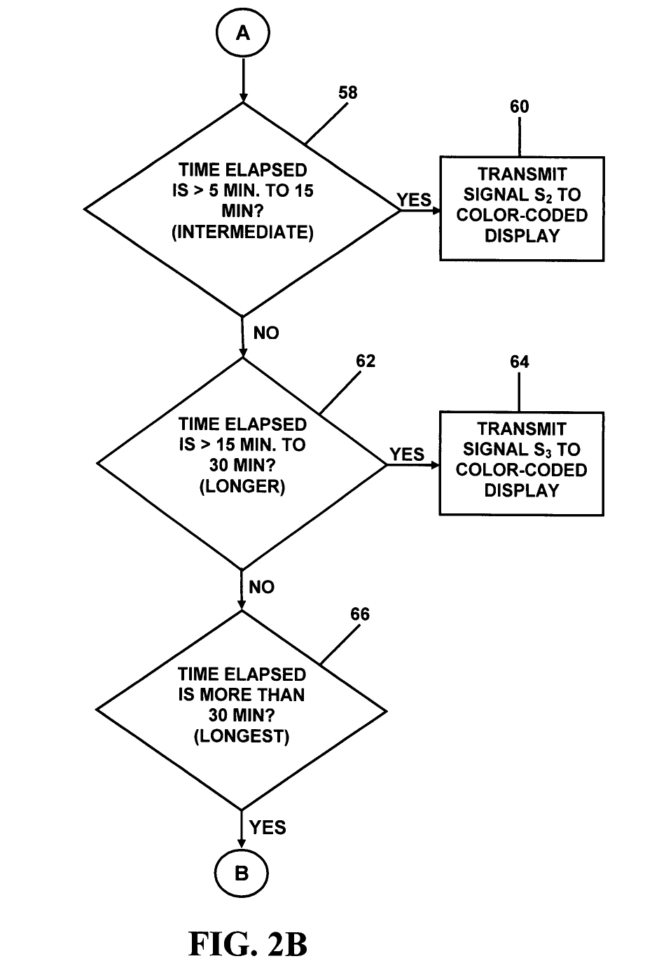

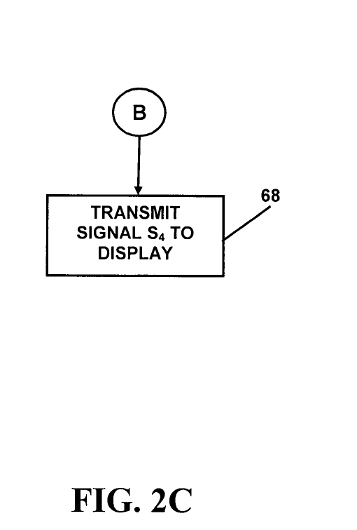

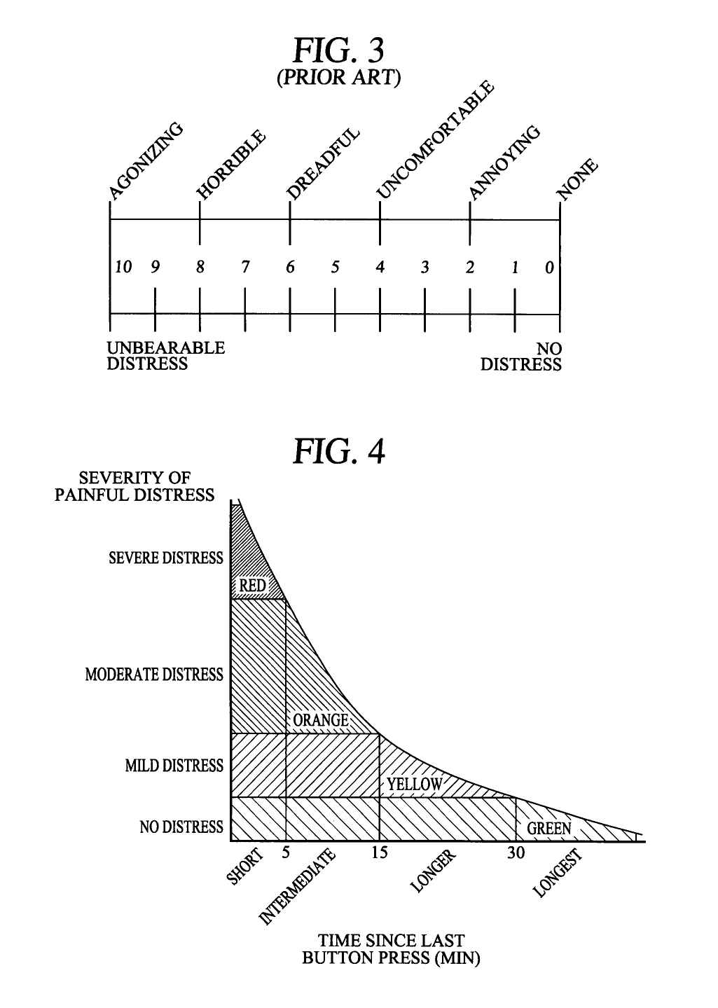

Referring to FIGS. 2A-2C, a method of monitoring the condition of a subject, in accordance with the present invention, will now be described.

As noted above, a patient or subject under study or for assessment is given the hand-held counter 16 (step 46). In each instance of the occurrence of a stimulus, such as a pain, the patient activates the counter by pressing its button 18 (step 48). The counter 16 records time and date of the activation by the patient and transmits a signal to the receiver/processor 12 (step 50). The receiver/processor measures the time elapsed since receiving the last signal (step 52) and determines whether the time elapsed is within up to five minutes (step 54) and, if yes, transmits a signal S₂ to the monitor 14 (step 56) to illuminate the display panel 20 in red (FIG. 5D). If, the time elapsed, since the last signal, is more than five minutes to fifteen minutes (step 58), the receiver/processor 12 transmits a signal S₂ to the monitor 14 (step 60) to illuminate display panel 22 in orange (FIG. 5C). If the time elapsed, since the last signal, is more than fifteen minutes to thirty minutes (step 62), the receiver/processor 12 transmits a signal S₃ (step 64) to the monitor 14 to illuminate the display panel 24 in yellow (FIG. 5B). If, on the other hand, the time elapsed is more than thirty minutes (step 66), the receiver/processor 12 transmits a signal S₄ (step 68) to the monitor 14 to illuminate display panel 26 in green (FIG. 5A). As noted above, the red, orange, yellow and green colors correspond to severe distress, moderate distress, mild distress, and no distress conditions of the patient.

In addition to measuring the time elapsed since the last signal, upon receiving a signal from the hand-held counter 16, the receiver/processor 12 also monitors the absence of a signal continuously, or intermittently at the expiration of a preset period (step 70) of, for example, 5 seconds to 2 minutes. Therefore, if the Short time elapses without a subsequent activation of the hand-held counter 16, the receiver/processor 12 transmits signal S₂ (step 60) to change the monitor 14 to illuminate the display panel 22 in orange, from the display panel 20 in red. Likewise, if the Intermediate time elapses without receiving a subsequent signal, the receiver/processor 12 transmits signal S₃ to illuminate the display panel 24 in yellow, from the display panel 22 in orange. Finally, if no subsequent signal is received for more than thirty minutes, the color on the monitor 14 changes to green (display panel 26 is illuminated). This allows for continuous monitoring of the level of painful distress by a healthcare provider.

The method illustrated in FIGS. 2A-2C and described above can be embodied in an appropriate software to be executed by the device or system of the present invention, or in conjunction therewith.

In the present invention, while it is contemplated that the monitor 14 will be located at, for example, a nurse's station or outside a patient's room in a healthcare facility, for monitoring the patient's condition, its location can be varied to suit the desired needs. For example, it can be incorporated into a single unit with the patient input module 10 and/or the receiver/processor 12, for field use or in an ambulatory situation.

It is noted herewith that while the present invention has been described/illustrated in terms of monitoring or assessing the painful distress condition of a subject, it can be used for other types of stimuli, such as happy, sad, depressed, well-being, etc.

While this invention has been described as having preferred sequences, ranges, steps, materials, structures, features, components, or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the appended claims.

What is claimed is:

1. A device for monitoring the condition of a subject, comprising:
a) an input member for generating one or more signals;
b) a processor for receiving said one or more signals from said input member and measuring a time elapsed since the last signal; and
c) a monitor for indicating a condition of the subject.

2. The device of claim 1, wherein:
a) the condition of the subject is indicated by an audio signal, a visual signal, or an audio-visual signal.

3. The device of claim 2, wherein:
a) said visual signal and said audio-visual signal each comprises a color-coded signal.

4. The monitoring device of claim 3, wherein:
a) said color-coded signal comprises at least one member selected from the group consisting of red, orange, yellow, green, and a combination thereof.

5. The device of claim 4, wherein:
a) the red, orange, yellow, and green signals indicate severe distress, moderate distress, mild distress, and no distress conditions, respectively, for the subject.

6. The device of claim 4, wherein:
a) the time elapsed comprises a plurality of periods each of a predetermined duration.

7. The device of claim 6, wherein:
a) the periods comprise short, intermediate, longer, and longest periods generally corresponding to zero to about 5 minutes, more than about 5 to about 15 minutes, more than about 15 minutes to about 30 minutes, and more than about 30 minutes, respectively.

8. The device of claim 7, wherein:
a) the short, intermediate, longer, and longest periods correspond to red, orange, yellow, and green signals.

9. The device of claim 1, wherein:
a) said input member comprises a portable counter, a pointing device, a data entry device, a telephone, a cell phone, a personal data assistant (PDA), a desktop computer, a laptop computer, a portable computing device, a remote control device, or a combination thereof.

10. The device of claim 1, wherein:
a) said monitor is located remotely from the subject.

11. The device of claim 1, wherein:
a) said input member comprises said processor.

12. The device of claim 1, wherein:
a) said input member comprises said processor and said monitor.

13. A device for monitoring the condition of a subject, comprising:
a) an input member for generating one or more user-initiated signals;
b) a processor for receiving said one or more signals from said input member and measuring a time elapsed since the last signal; and
c) a monitor for indicating a condition of the subject, the condition comprising at least one of severe distress, moderate distress, mild distress, and no distress.

14. The device of claim 13, wherein:
a) the condition of the subject is indicated by an audio signal, a visual signal, or an audio-visual signal.

15. The device of claim 14, wherein:
a) said visual signal and said audio-visual signal each comprises a color-coded signal.

16. The device of claim 15, wherein:
a) said color-coded signal comprises at least one member selected from the group consisting of red, orange, yellow, green, and a combination thereof.

17. The device of claim 16, wherein:
a) the red, orange, yellow, and green signals correspond to severe distress, moderate distress, mild distress, and no distress conditions, respectively, for the subject.

18. The device of claim 16, wherein:
a) the time elapsed comprises a plurality of periods each of a predetermined duration.

19. The device of claim 18, wherein:
a) the periods comprise short, intermediate, longer, and longest periods generally corresponding to zero to about 5 minutes, more than about 5 to about 15 minutes, more than about 15 minutes to about 30 minutes, and more than about 30 minutes, respectively.

20. The device of claim 19, wherein:
a) the short, intermediate, longer, and longest periods correspond to red, orange, yellow, and green signals.

21. The device of claim 13, wherein:
a) said input member comprises a portable counter, a pointing device, a data entry device, a telephone, a cell phone, a personal data assistant (PDA), a desktop computer, a laptop computer, a portable computing device, a remote control device, or a combination thereof.

22. The device of claim 13, wherein:
a) said monitor is located remotely from the subject.

23. The device of claim 13, wherein:
a) said input member comprises said processor.

24. The device of claim 13, wherein:
a) said input member comprises said processor and said monitor.

25. A device for monitoring the condition of a subject, comprising:
a) an input member for generating one or more signals;
b) a processor for measuring a time elapsed since receiving the last signal from said input member; and
c) a monitor for indicating a condition of the subject.

26. The device of claim 25, wherein:
a) said one or more signals are generated by a user.

27. The device of claim 25, wherein:
a) the time elapsed comprises a plurality of periods each of a predetermined duration.

28. The device of claim 27, wherein:
a) the periods comprise short, intermediate, longer, and longest periods corresponding to severe distress, moderate distress, mild distress, and no distress conditions, respectively, for the subject.

29. The device of claim 28, wherein:
a) said monitor indicates a moderate distress condition for the subject when the short period elapses.

30. The device of claim 28, wherein:
a) said monitor indicates a mild distress condition for the subject when the intermediate period elapses.

31. The device of claim 28, wherein:
a) said monitor indicates a no distress condition for the subject when the longer period elapses.

32. The device of claim 28, wherein:
a) said monitor indicates a no distress condition for the subject when the longest period elapses.

33. A system for reporting the condition of a subject, comprising:
a) an input member for generating one or more user-initiated signals;
b) a processor for receiving said one or more signals from said input member and measuring a time elapsed since the last signal; and
c) said processor recording time and frequency data for the signals over a predetermined period.

34. The system of claim 33, further comprising:
a) a monitor for indicating a condition of the subject.

35. The system of claim 33, further comprising:
a) an online database server.

36. The system of claim 35, further comprising:
a) a computing device.

37. The system of claim 36, wherein:
a) said computing device comprises said processor.

38. The system of claim 36, wherein:
a) said processor is in communication with said server and said computing device by an Internet connection.

39. An outpatient painful distress reporting system, comprising:
a) a patient input member for generating one or more signals in each instance of the occurrence of a painful stimulus;
b) a processor for receiving said one or more signals from said patient input member and measuring a time elapsed since the last signal;
c) a monitor for indicating a condition of the patient in each instance a signal is received by said processor, the condition comprising at least one of severe distress, moderate distress, mild distress, and no distress; and
d) said processor recording time and frequency data for the signals and the condition of the patient over a predetermined period.

40. The system of claim 39, further comprising:
a) an online database server.

41. The system of claim 40, further comprising:
a) a computing device.

42. The system of claim 41, wherein:
a) the condition of the patient is indicated by an audio signal, a visual signal, or an audio-visual signal.

43. The system of claim 41, wherein:
a) said computing device comprises said processor.

44. The system of claim 41, wherein:
a) said processor is in communication with said server and said computing device by an Internet connection.

45. A method of monitoring the condition of a subject, comprising the steps of:
a) providing an input member to a user for generating a signal in each instance of the occurrence of a stimulus;
b) measuring a time elapsed since receiving the last signal from the input member; and
c) indicating a condition of the subject based on the time elapsed as measured in step b).

46. The method of claim 45, wherein:
the step b) comprises measuring a plurality of periods each of a predetermined duration.

47. The method of claim 46, wherein:
the periods comprise short, intermediate, longer, and longest periods generally corresponding to zero to about 5 minutes, more than about 5 to about 15 minutes, more than about 15 minutes to about 30 minutes, and more than about 30 minutes, respectively.

48. The method of claim 47, wherein:
the short, intermediate, longer, and longest periods correspond to first, second, third, and fourth conditions for the subject.

49. The method of claim 48, wherein:
the step c) comprises indicating the first condition for the subject when the time elapsed is within or equal to the short period.

50. The method of claim 48, wherein:
the step c) comprises indicating the second condition for the subject when the short period elapses.

51. The method of claim 48, wherein:
the step c) comprises indicating the second condition for the subject when the time elapsed is within or equal to the intermediate period.

52. The method of claim 48, wherein:
the step c) comprises indicating the third condition for the subject when the intermediate period expires.

53. The method of claim 48, wherein:
the step c) comprises indicating the third condition for the subject when the time elapsed is within or equal to the longer period.

54. The method of claim 48, wherein:
the step c) comprises indicating the fourth condition for the subject when the longer period expires.

55. The method of claim 45, further comprising:
d) repeating steps b) and c) in each instance of receiving a signal from the input member.

56. The method of claim 45, further comprising:
d) repeating steps b) and c) in each instance of the absence of a signal from the input member for a predetermined period.

57. The method of claim 48, wherein:
the first, second, third, and fourth conditions correspond to severe distress, moderate distress, mild distress, and no distress conditions, respectively, for the subject.

58. A method of reporting the condition of a subject, comprising the steps of:
a) providing an input member to a user for generating a signal in each instance of the occurrence of a stimulus;
b) measuring a time elapsed since receiving the last signal from the input member; and
c) indicating a condition of the subject based on the time elapsed as measured in step b); and
d) recording time and frequency data for the signals over a predetermined period.

59. The method of claim 58, further comprising:
e) providing access to the time and frequency data to a care provider via the Internet.

60. The method of claim 58, wherein:
the stimulus comprises a painful or well-being stimulus.
